(19) United States
(12) Patent Application Publication
(10) Pub. No.: US 2023/0401657 A1
(43) Pub. Date: Dec. 14, 2023

(54) HOTEL BOOKING COORDINATION SYSTEM AND PERFORMANCE PLATFORM

(71) Applicant: HotelEngine, Inc., Denver, CO (US)

(72) Inventor: Elia WALLEN, Denver, CO (US)

(21) Appl. No.: 18/208,504

(22) Filed: Jun. 12, 2023

Related U.S. Application Data
(60) Provisional application No. 63/351,703, filed on Jun. 13, 2022.

(51) Int. Cl. G06Q 50/12; G06Q 10/0639; G06Q 10/02

(52) U.S. Cl. CPC G06Q 50/12; G06Q 10/06393; G06Q 10/02

(57) ABSTRACT

An example method described herein includes receiving booking data for a booking of a hotel from a first supplier system used to create the booking and aggregating the booking data with additional booking data for the hotel to create performance analytics data, where the additional booking data includes data for bookings of the hotel from at least a second supplier system used to create the bookings. The method further includes generating a performance score for the hotel based on the performance analytics data and displaying the performance score and the performance analytics data at a performance platform interface accessible by a user associated with the hotel.

### CROSS-REFERENCE TO RELATED APPLICATIONS

The present application claims the benefit of priority to U.S. Provisional Patent Application No. 63/351,703, filed Jun. 13, 2022, entitled “HOTEL BOOKING COORDINATION SYSTEM AND PERFORMANCE PLATFORM,” the disclosure of which is hereby incorporated herein by reference in its entirety.

### BACKGROUND

Many hotels utilize various booking systems to allow customers, and those booking on behalf of customers, to book rooms at the hotels. Such systems may not be configured for intercommunication, such that hotels are unable to aggregate data about bookings across such systems to gauge overall performance of the hotel in generating new bookings. Further, hotels are often evaluated by customers and/or management based on customer reviews, which may not be objective and may not include information that is useful or actionable by a hotel to increase its ratings across various platforms.

### SUMMARY

An example method described herein includes receiving booking data for a booking of a hotel from a first supplier system used to create the booking and aggregating the booking data with additional booking data for the hotel to create performance analytics data, where the additional booking data includes data for bookings of the hotel from at least a second supplier system used to create the bookings. The method further includes generating a performance score for the hotel based on the performance analytics data and displaying the performance score and the performance analytics data at a performance platform interface accessible by a user associated with the hotel.

Another example method disclosed herein includes receiving a request to view a performance platform interface for a hotel and querying a datastore including aggregated booking data for the hotel for performance analytics data and a performance score for the hotel. The method further includes displaying the performance analytics data and the performance score for the hotel at the performance platform interface.

Additional embodiments and features are set forth in part in the description that follows, and will become apparent to those skilled in the art upon examination of the specification and may be learned by the practice of the disclosed subject matter. A further understanding of the nature and advantages of the present disclosure may be realized by reference to the remaining portions of the specification and the drawings, which form a part of this disclosure. One of skill in the art will understand that each of the various aspects and features of the disclosure may advantageously be used separately in some instances, or in combination with other aspects and features of the disclosure in other instances.

### BRIEF DESCRIPTION OF THE DRAWINGS

The description will be more fully understood with reference to the following figures in which components are not drawn to scale, which are presented as various examples of the present disclosure and should not be construed as a complete recitation of the scope of the disclosure, characterized in that:

FIG. 1 illustrates an example system including a booking coordination system in accordance with various embodiments of the disclosure.

FIG. 2 illustrates an example booking coordination system in communication with various other systems in accordance with various embodiments of the disclosure.

FIG. 3 is a schematic diagram of an example computer system implementing various embodiments in the examples described herein.

FIG. 4 illustrates an example performance platform interface generated by a booking coordination system in accordance with various embodiments of the disclosure.

FIG. 5 illustrates another example performance platform interface generated by a booking coordination system in accordance with various embodiments of the disclosure.

FIG. 6 illustrates an example process for generation of a performance score by a booking coordination system in accordance with various embodiments of the disclosure.

FIG. 7 illustrates an example process for configuring a performance platform interface by a booking coordination system in accordance with various embodiments of the disclosure.

### DETAILED DESCRIPTION

Generally, the hotel industry does not have a non-subjective quantitative metric that is usable for comparing performance of various hotels by consumers, suppliers, entities owning several hotels, and other interested parties. For example, customer ratings of hotels may be frequently used to compare the performance of various hotels. However, such ratings are subjective and do not take into account objective performance data for hotels, such as revenue, nights booked, return stays, and the like. Further, such ratings may frequently be skewed by customers having very negative or positive experiences, such that the ratings are not representative of the experience of an average customer of the hotel. Other measures, such as revenue of the hotel, average occupancy rates, and the like, may be difficult to use to compare hotels in different markets, serving different clientele, and the like. For example, hotels near airports, convention centers, or other similar venues may have consistently higher occupancy rates than hotels in rural areas. Further, some hotels, such as those near beaches, ski resorts, or other seasonal locations may have seasonally fluctuating occupancy rates. Comparisons between such differently situated hotels may be difficult without additional aggregated data or contextual information.

Consumers, travel agents, and other entities may generally book hotel rooms through various suppliers (e.g., travel agents, group travel coordinators, and the like), where each supplier uses its own proprietary systems to complete bookings and communicate with the hotel for bookings. It may be difficult to aggregate data about the total bookings of a hotel when each supplier communicates separately with the hotel. For example, a hotel may be able to view various statistics about bookings through each supplier, but may not be able to view statistics across the different suppliers. In some situations, the statistics received from different suppliers may be different such that aggregation of such statistics is not possible, or is time, cost, or otherwise resource prohibitive. Accordingly, it may be difficult for hotels to holistically view information about performance and, accordingly, to improve performance based on such information.

Hotels may have difficulty identifying concrete areas for improvement using available performance metrics. For example, customer reviews may include numeric ratings without further information about why a customer selected a particular rating. Similarly, hotel owners, managers, and the like may observe trends in hotel bookings, but may be unable to see what factors may be driving such trends. For example, hotels with amenity listings may receive more bookings on a particular booking platform, such that providing amenity listings may increase the hotel's bookings through the booking platform. However, such information may not be available to owners, managers, or other parties interested in the performance of the hotel.

The booking coordination system 102 described herein may provide coordination between hotel systems 106, supplier systems 104 (e.g., booking platforms), hotel devices 112, and/or various user devices 114. Such coordination may allow the booking coordination system 102 to organize and aggregate booking data from various sources, including multiple supplier systems 104 and hotel systems 106. Using the aggregated booking information, the booking coordination system 102 may generate a performance score, which may be used to evaluate performance of a single hotel, as well as to compare hotels to one another. The booking coordination system 102 may further configure and display (e.g., via the hotel device 112) a performance platform interface displaying the performance score and/or various data used by the booking coordination system 102 to generate the performance score. The performance platform interface may, in various examples, provide information regarding how to increase the performance score. The booking coordination system 102 may further configure and update the performance platform interface in real-time (or near real-time), such that an owner, manager, or other interested party may evaluate and track the performance of the hotel in real-time.

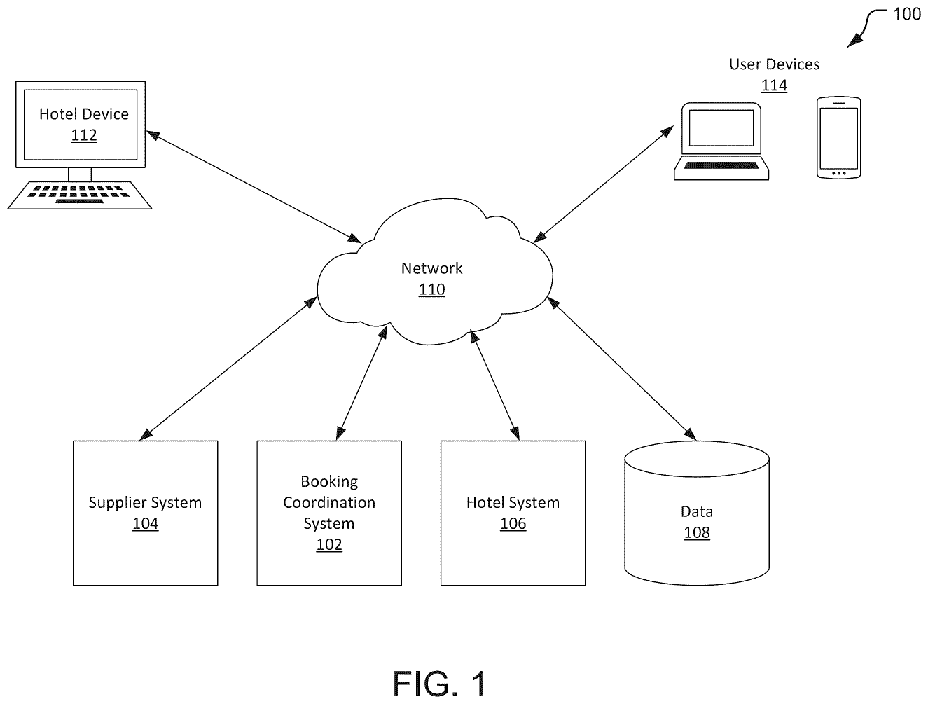

Turning now to the drawings, FIG. 1 illustrates an example system 100 including a booking coordination system 102 in accordance with various embodiments of the disclosure. The booking coordination system 102 may generally communicate with various systems, such as supplier systems 104 and the hotel system 106 and various data sources, such as datastore 108 to generate performance scores for hotels and/or to configure performance platform interfaces at user devices, such as the hotel device 112. In various examples, each of the supplier system 104, the hotel system 106, and the hotel device 112 may communicate with the booking coordination system 102 via the network 110. The user devices 114 may communicate with the various supplier systems 104 (e.g., hotel booking platforms) through the network 110.

The booking coordination system 102 may generally serve as an interface between the supplier systems 104, the hotel system 106, and/or the hotel device 112. For example, the booking coordination system 102 may receive bookings for the hotel from the various supplier systems 104 and/or the hotel system 106. The booking coordination system 102 may aggregate the booking data to generate various metrics and/or performance analytics data used to generate a performance score for the hotel. Such metrics, performance analytics data, and/or performance scores may, in various examples, be viewed via a performance platform interface displayed at the hotel device 112. For example, a user at the hotel device 112 may request to view the performance platform interface to track the performance of the hotel. Upon receiving the request, the booking coordination system 102 may query supplier systems 104 and the hotel system 106 to obtain any new bookings for the hotel (e.g., bookings made using user devices 114 in communication with a supplier system 104). The booking coordination system 102 may then aggregate the new bookings with existing booking data and/or other data about the hotel (e.g., stored at data 108), to generate the metrics, performance analytics data, and/or performance score to be displayed at the hotel device 112. The booking coordination system 102 may use the generated data to configure the performance platform interface for display at the hotel device 112.

It should be noted that in some embodiments, the performance data may be displayed on a customer or consumer interface in the form of a badge or other visual indicator (e.g., numeric value), when the hotel information is returned as a result in a results listing or the like. In this manner the user may easily and readily identify the performance score without having to select or drill down into multiple screens or profiles of the hotel.

The booking coordination system 102 may be generally implemented by a computing device or combinations of computing resources in various embodiments. In various examples, the booking coordination system 102 may be implemented by one or more servers, cloud computing resources, and/or other computing devices. The booking coordination system 102 may, for example, utilize various processing resources to communicate with various services, access data, configure user portals, create and/or utilize building digital assets, and the like. The booking coordination system 102 may further include memory and/or storage locations to store program instructions for execution by the processor and various data utilized by the platform coordination system.

The supplier system 104 and the hotel system 106 may similarly be implemented by one or more computing devices or combinations of computing resources in various embodiments. Supplier systems 104 may include, in various examples, systems used by resellers of hotel rooms (e.g., Priceline®, Expedia®, Kayak®, and the like), systems used by travel agents or other entities who book hotel rooms on behalf of other customers, systems and/or services utilized by hotels to provide options for bookings (e.g., third party services linked to the hotel's website), and the like. For example, a supplier system may be those that receive hotel booking information directly or indirectly by the hotels, such as by interfacing directly with the hotel systems through an API or the like. Supplier systems may also allow users to engage with and book rooms at various hotels. The hotel system 106 may include systems utilized by the hotel to book rooms at the hotel. For example, user devices 114 may connect directly to the hotel system 106 via the network 110 to book rooms at the hotel. In various examples, the hotel system 106 may provide booking services for one hotel (e.g., one physical location). In some examples, the hotel system 106 may provide booking services for multiple hotels, such as all hotels in a specific chain or grouping of chains (e.g., a brand). The booking coordination system 102 may interface with supplier systems 104, one or more hotel systems 106, and/or other types of systems used to book hotel rooms and/or services.

The network 110 may be implemented using one or more of various systems and protocols for communications between computing devices. In various embodiments, the network 108 or various portions of the network 108 may be implemented using the Internet, a local area network (LAN), a wide area network (LAN), a wide area network (WAN), and/or other networks. In addition to traditional data networking protocols, in some embodiments, data may be communicated according to protocols and/or standards including near field communication (NFC), Bluetooth, cellular connections, and the like.

Generally, the hotel device 112 and user devices 114 may be devices belonging to end users. For example, the hotel device 112 may be utilized by an owner or manager of a hotel and/or group of hotels. User devices 114 may be devices utilized by customers to book hotel rooms (e.g., via supplier systems 104 and/or the hotel system 106). Customers may include customers intending to occupy rooms, people or entities booking hotels on behalf of others (e.g., travel agents), and the like. In various examples, user devices 114 may belong to other users who may have access to performance platforms for multiple hotels.

In various implementations, the hotel device 112, the user devices 114 and/or additional user devices may be implemented using any number of computing devices including, but not limited to, a computer, a laptop, tablet, mobile phone, smart phone, wearable device (e.g., AR/VR headset, smart watch, smart glasses, or the like), smart speaker, vehicle (e.g., automobile), or appliance. Generally, the user devices may include one or more processors, such as a central processing unit (CPU) and/or graphics processing unit (GPU). The user devices may generally perform operations by executing executable instructions (e.g., software) using the processor(s).

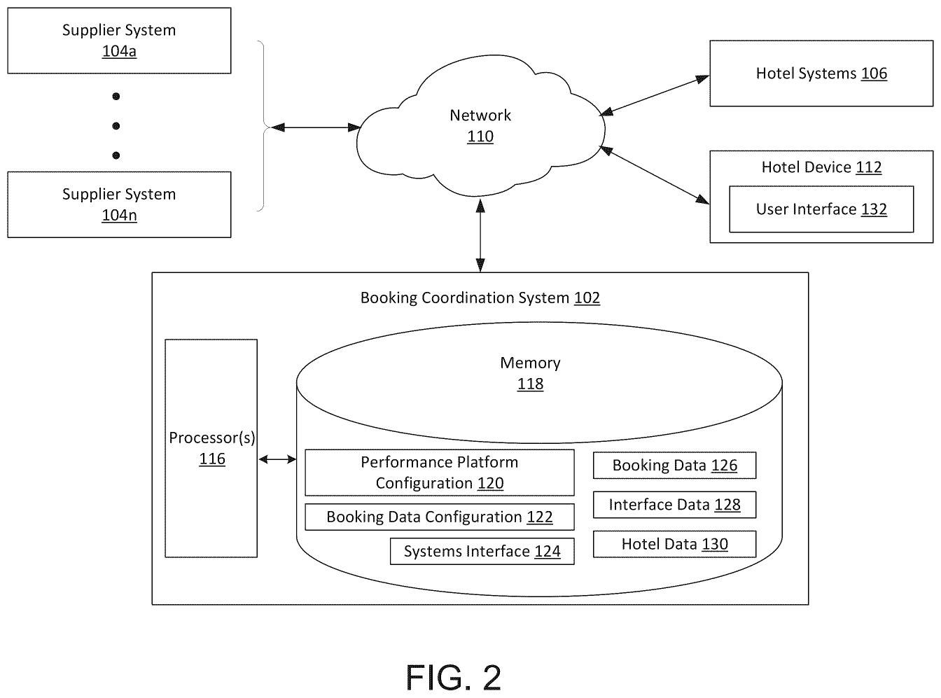

FIG. 2 illustrates an example booking coordination system 102 in communication with various other systems. The booking coordination system 102 generally includes various modules and/or components for performing various functions of the booking coordination system 102. For example, the booking coordination system 102 may include a systems interface 124 for communication with various supplier systems 104a-104n and/or the hotel system 106. The booking coordination system 102 may further include booking data configuration 122 to aggregate various booking data, calculate various metrics, generate performance scores, and the like. The booking coordination system 102 may further include functionality for performance platform configuration 120, which may populate and configure a performance platform interface including booking metrics, performance analytics data, and/or a performance score (e.g., for display at a user interface 132 of the hotel device 112). The booking coordination system 102 may further store and/or utilize various types of data utilized in performing the functions of the booking coordination system 102. For example, the booking coordination system 102 may store and/or access booking data 126, interface data 128, and/or hotel data 130, in various examples.

In various implementations, the booking coordination system 102 may include or utilize one or more hosts or combinations of compute resources, which may be located, for example, at one or more servers, cloud computing platforms, computing clusters, and the like. Generally, the booking coordination system 102 is implemented by compute resources including hardware for memory 118 and one or more processors 116. For example, the platform coordination system 102 may utilize or include one or more processors, such as a CPU, GPU, and/or programmable or configurable logic. In some embodiments, various components of the booking coordination system 102 may be distributed across various computing resources, such that the components of the booking coordination system 102 communicate with one another through the network 110 or using other communications protocols. For example, in some embodiments, the booking coordination system 102 may be implemented as a serverless service, where computing resources for various components of the booking coordination system 102 may be located across various computing environments (e.g., cloud platforms) and may be reallocated dynamically and/or automatically according to, for example, resource usage of the booking coordination system 102. In various implementations, the booking coordination system 102 may be implemented using organizational processing constructs such as functions implemented by worker elements allocated with compute resources, containers, virtual machines, and the like.

The memory 118 may include instructions for various functions of the booking coordination system 102 which, when executed by processor 116, perform various functions of the booking coordination system 102. The memory 118 may further store data and/or instructions for retrieving data used by the booking coordination system 102. Similar to the processor 116, memory resources utilized by the booking coordination system 102 may be distributed across various physical computing devices. In some examples, memory 118 may access instructions and/or data from other devices or locations, and such instructions and/or data may be read into memory 118 to implement the booking coordination system 102.

In various embodiments, memory 118 may store booking data 126. Booking data 126 may include, in various examples, information related to bookings of one or more hotels. Booking data 126 may be stored at the memory 118 using various data structures. In some examples, booking data 126 may further include instructions for accessing additional booking data stored at another location accessible by the booking coordination system 102, such as the datastore 108. For example, instructions for accessing additional booking data may include queries and/or other information for obtaining booking data from a datastore 108. Generally, booking data 126 may include various types of information related to a booking such as, number of nights booked, platform used to make the booking (e.g., a supplier system 104 and/or the hotel system 106), the room rate or rates applicable to the booking, a customer type (e.g., business traveler, member of a group, individual customer, etc.), and/or other information related to a booking of the hotel.

In various embodiments, memory 118 may store interface data 128. Interface data 128 may include various types of information utilized by the booking coordination system 102 to generate a performance platform interface. For example, interface data 128 may include pre-structured queries to new booking data from various supplier systems 104a-104n and/or the hotel system 106 in communication with the booking coordination system 102. In various examples, interface data 128 may further include one or more templates for generating a performance platform interface to display at a user interface 132 of the hotel device 112. For example, a template may include types of data to obtain from the supplier systems 104a-104n, the hotel system 106, from booking data 126, or from other locations to configure the performance platform interface.

In various embodiments, memory 118 may store hotel data 130. Hotel data 130 may include, in various examples, various information about the hotel associated with the hotel device 112. In some examples, hotel data 130 may further include information about other hotels (e.g., hotels in the same chain, geographic region, and/or other grouping). Hotel data 130 may include, for example, hotel market and/or locale, hotel type (e.g., suites, bed and breakfast, etc.), and the like. In some examples, hotel data 130 may further include a subscription level for the hotel to the booking coordination system 102. For example, different subscription levels may allow hotels to view different levels of aggregated data, comparisons to other hotels, and the like. A hotel with a higher level subscription may further be provided with more information on how to improve the hotel's performance score and/or may be provided with other options and/or information through the booking coordination system 102.

The memory 118 may include instructions implementing performance platform configuration 120 when executed by the processor 116. In various examples, performance platform configuration 120 may include instructions for configuring a performance platform interface for a hotel, and communicating the configured performance platform interface to the hotel device 112 (or another computing device) for viewing (e.g., via the user interface 132 of the hotel device 112. In various examples, performance platform configuration 120 may receive a request to configure a performance platform interface for a hotel from the systems interface 124. Performance platform configuration 120 may access interface data 128 to access various instructions for configuration of the performance platform interface, such as, in some examples, a template for the interface. Based on such instructions and/or templates, performance platform configuration 120 may then communicate with other components and/or access other data of the booking coordination system 102 to generate the performance platform interface. For example, performance platform configuration 120 may access booking data 126, interface data 128, and/or hotel data 130 to obtain information for display via the performance platform interface. In some examples, performance platform configuration 120 may further communicate with booking data configuration 122 and/or the systems interface 124 to obtain additional information to be displayed at the performance platform interface, such as a performance score generated by booking data configuration 122.

In various embodiments, the memory 116 may include instructions implementing booking data configuration 122 when executed by the processor 116. Booking data configuration 122 may generally aggregate new booking data for a hotel with existing booking data, as well as generate performance analytics data and/or performance scores from the aggregated booking data. For example, booking data configuration 122 may access booking data 126 to access existing booking data for a hotel, and may communicate with the systems interface 124 to retrieve new booking data for a hotel. Booking data configuration 122 may aggregate such booking data to generate various booking metrics which may be used, in various examples, to generate performance analytics data and/or a performance score. For example, booking data configuration 122 may use the aggregated data to determine average customer ratings for a hotel, average number of nights per booking, total nights booked, average room rate for bookings, and the like. Booking data configuration 122 may further analyze booking data to determine which suppliers are used for bookings, days of the week of check-in, average spend per supplier, and the like. Such metrics and/or analytics may be used to generate a performance score for the hotel. In addition, such metrics and/or analytics may be used by performance platform configuration 120 to configure the performance platform interface. For example, the performance score, the performance analytics, and/or graphs generated using metrics determined by booking data configuration 122 may be displayed using the performance platform interface.

The memory 118 may include instructions implementing a systems interface 124 when executed by the processor 116. The systems interface 124 may generally communicate with systems external to the booking coordination system 102 to receive requests, access data, send data, and the like. For example, the systems interface 124 may communicate with the hotel device 112 to receive requests to view the performance platform interface at the hotel device 112. Similarly, the systems interface 124 may communicate with supplier systems 104a-104n and the hotel system 106 to obtain additional booking data for the hotel. In such examples, the systems interface 124 may utilize interface data 128 to structure queries for the supplier systems 104a-104n and/or the hotel system 106 to obtain additional booking data. The systems interface 124 may communicate with other components of the booking coordination system 102. For example, the systems interface 124 may communicate a request from the hotel device 112 to view the performance platform interface to performance platform configuration 120. Similarly, the systems interface 124 may communicate with booking data configuration 122 to provide booking data configuration 122 with additional booking data received by the systems interface 124 from any of the supplier systems 104a-104n and/or the hotel system 106.

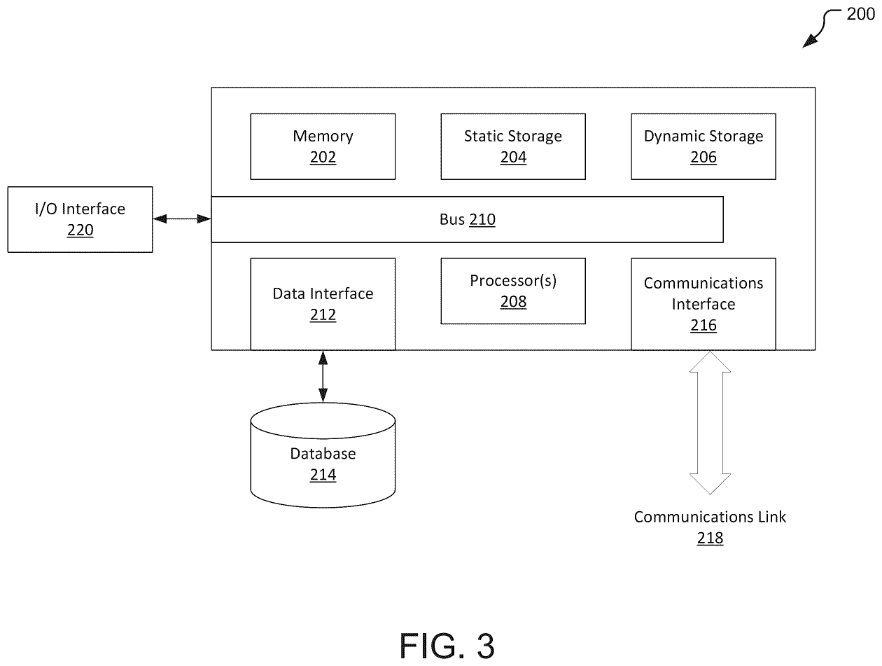

The booking coordination system 102 may be implemented using various computing systems. Turning to FIG. 3, an example computing system 200 may be used for implementing various embodiments in the examples described herein. For example, processor 116 and memory 118 may be located at one or several computing systems 200. In various embodiments, the hotel device 112 and/or one or more user devices 114 are also implemented by a computing system 200. Various systems, such as supplier systems 104 and/or the hotel system 106 may be implemented by one or more computing systems 200. This disclosure contemplates any suitable number of computing systems 200. For example, the a computing system 200 may be a server, a desktop computing system, a mainframe, a mesh of computing systems, a laptop or notebook computing system, a tablet computing system, an embedded computer system, a system-on-chip, a single-board computing system, or a combination of two or more of these. Where appropriate, the computing system 200 may include one or more computing systems; be unitary or distributed; span multiple locations; span multiple locations; span multiple machines; span multiple data centers; or reside in a cloud, which may include one or more cloud components in one or more networks.

Computing system 200 includes a bus 210 (e.g., an address bus and a data bus) or other communication mechanism for communicating information, which interconnects subsystems and devices, such as processor 208, memory 202 (e.g., RAM), static storage 204 (e.g., ROM), dynamic storage 206 (e.g., magnetic or optical), communications interface 216 (e.g., modem, Ethernet card, a network interface controller (NIC) or network adapter for communicating with an Ethernet or other wire-based network, a wireless NIC (WNIC) or wireless adapter for communicating with a wireless network, such as a WI-FI network), input/output (I/O) interface 220 (e.g., keyboard, keypad, mouse, microphone). In particular embodiments, the computing system 200 may include one or more of any such components.

In particular embodiments, processor 208 includes hardware for executing instructions, such as those making up a computer program. The processor 208 circuitry includes circuitry for performing various processing functions, such as executing specific software for perform specific calculations or tasks. In particular embodiments, I/O interface 220 includes hardware, software, or both, providing one or more interfaces for communication between computing system 200 and one or more I/O devices. Computing system 200 may include one or more of these I/O devices, where appropriate. One or more of these I/O devices may enable communication between a person and computing system 200.

In particular embodiments, communications interface 216 includes hardware, software, or both providing one or more interfaces for communication (such as, for example, packet-based communication) between computing system 200 and one or more other computer systems or one or more networks. One or more memory buses (which may each include an address bus and a data bus) may couple processor 208 to memory 202. Bus 210 may include one or more memory buses, as described below. In particular embodiments, one or more memory management units (MMUs) reside between processor 208 and memory 202 and facilitate accesses to memory 202 requested by processor 208. In particular embodiments, bus 210 includes hardware, software, or both coupling components of computing system 200 to each other.

According to particular embodiments, computing system 200 performs specific operations by processor 208 executing one or more sequences of one or more instructions contained in memory 202. For example, instructions for performance platform configuration 120, booking data configuration 122, and/or the systems interface 124 may be contained in memory 202 and may be executed by the processor 208. Such instructions may be read into memory 202 from another computer readable/usable medium, such as static storage 204 or dynamic storage 206. In alternative embodiments, hard-wired circuitry may be used in place of or in combination with software instructions. Thus, particular embodiments are not limited to any specific combination of hardware circuitry and/or software. In various embodiments, the term “logic” means any combination of software or hardware that is used to implement all or part of particular embodiments disclosed herein.

The term “computer readable medium” or “computer usable medium” as used herein refers to any medium that participates in providing instructions to processor 208 for execution. Such a medium may take many forms, including but not limited to, nonvolatile media and volatile media. Non-volatile media includes, for example, optical or magnetic disks, such as static storage 204 or dynamic storage 206. Volatile media includes dynamic memory, such as memory 202.

Computing system 200 may transmit and receive messages, data, and instructions, including program, e.g., application code, through communications link 218 and communications interface 216. Received program code may be executed by processor 208 as it is received, and/or stored in static storage 204 or dynamic storage 206, or other storage for later execution. A database 214 may be used to store data accessible by the computing system 200 by way of data interface 212. For example, booking data 126, interface data 128, and/or hotel data 130 may each be stored using a database 214. In various examples, communications link 218 may communicate with, for example, user devices to display user interfaces to the platform coordination system 102.

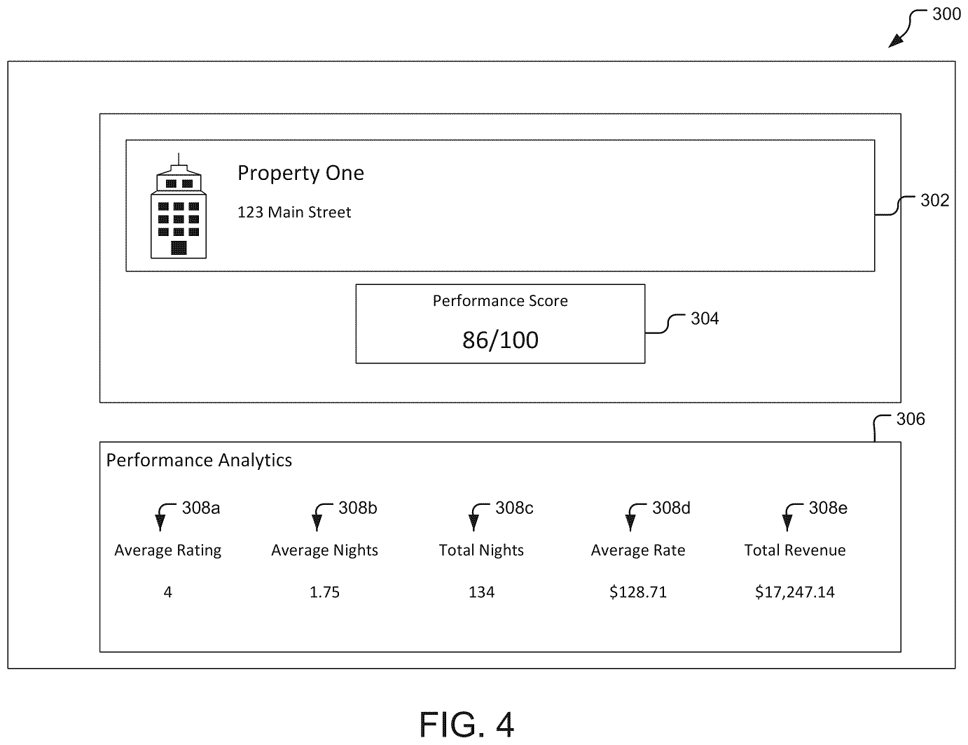

FIG. 4 illustrates an example performance platform interface 300 generated by the booking coordination system 102. The performance platform interface 300 may be generated by the booking coordination system 102 responsive to a request (e.g., from the hotel device 112) to access the booking coordination system 102 and/or to view the performance platform interface 300. The performance platform interface 300 may generally include information about the hotel, such as the information shown in element 302 of the interface 300. The performance platform interface 300 may further include an element 304 showing a performance score for the hotel. The performance score is shown as a number on a scale to 100 but, in various examples, the performance score may be expressed as a percentage a number on a different scale (e.g., from 0-10), and the like. In some examples, the performance platform interface 300 may include a badge or other graphic indicating that the hotel is high performing. Such a badge may, in various examples, be displayed when the performance score of the hotel is above a certain threshold. For example, where the performance score is calculated on a score of 0-100, the high performance badge may be displayed for hotels having a performance score over 90. Such a badge may further be displayed on other interfaces which are consumer facing, enabling the consumer to easily identify high-performing hotels.

Element 306 of the performance platform interface 300 may display various performance analytics 308a-308e used by the booking coordination system 102 in calculating the performance score for the hotel. The performance analytics 308a-308e may be calculated based on booking data from multiple supplier systems 104a-104n and the hotel system 106. Accordingly, the performance analytics 308a-308n may provide statistics via the performance platform interface 300 that would be difficult to view without the aggregation provided by the booking coordination system 102. Further, a user may have the ability to view what types of data are used in generating the performance score for the hotel.

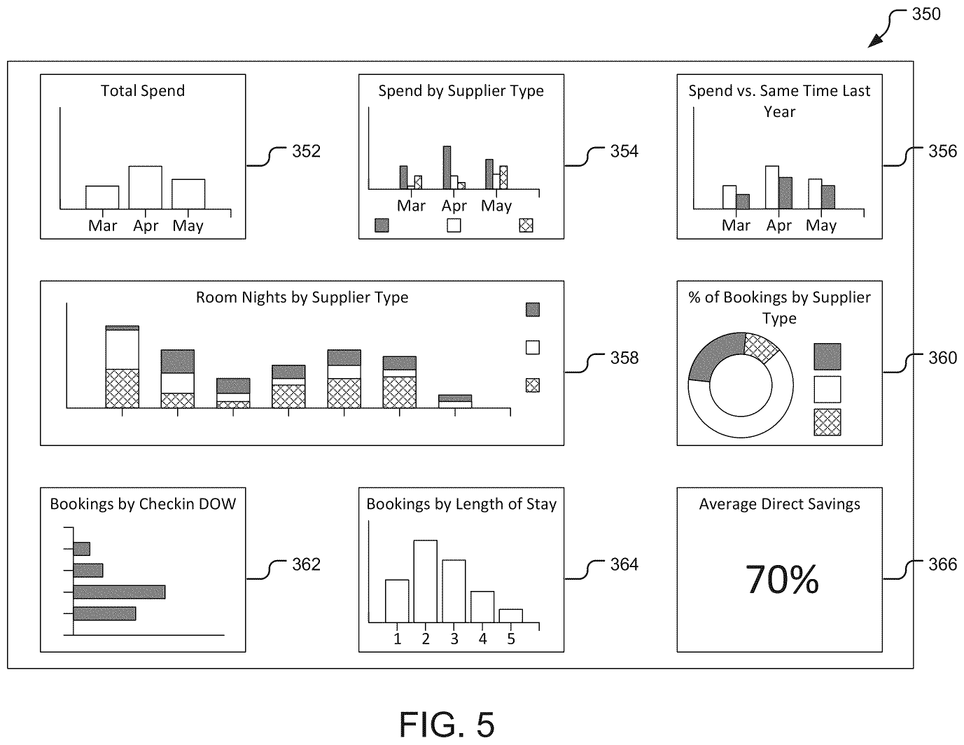

FIG. 5 illustrates another example performance platform interface 350 generated by the booking coordination system 102. In various examples, the performance platform interface 350 may be displayed with the performance platform interface 300 (e.g., the interface 350 may be viewable by scrolling down from the interface 300). The performance platform interface 350 generally includes tiles 352-256, which may display various metrics or aspects of booking data aggregated by the booking coordination system 102. In some examples, a hotel may choose which of the tiles are visible and/or tiles may be visible to some hotels based on, for example, a subscription level of the hotel to the booking coordination system 102. The data displayed in the tiles may assist hotels in improving their associated performance scores, by visually (e.g., graphically) displaying various aspects of the hotel's performance. Such visual displays improve upon conventional ways of viewing aggregated data (e.g., using spreadsheets), as the visual displays may be easier to utilize and more informative. For example, the visual displays may help users to view trends in booking data more quickly than using numbers in spreadsheets alone.

The data displayed at the performance platform interface 350 may further help the hotel to determine what types of actions to take to increase its performance score. For example, tile 358 shows the share of rooms booked by supplier type for each day of the week. Using the graph displayed at tile 358, the hotel (e.g., a manager) may observe that one type of supplier books a relatively smaller share of rooms certain days of the week. To work towards more rooms being booked by that supplier, the hotel may offer discounts through that supplier on nights where the graph shows the supplier books a smaller share of rooms. The graphical data displayed in tile 360 may be used similarly. For example, the hotel may run discounts or other special offers for a supplier booking a smaller number of rooms at the hotel. In another example, the hotel may utilize the graphical data shown in tile 364 to determine that the hotel may increase its performance score by increasing the number of longer stays booked at the hotel. Accordingly, the hotel may elect to run promotions reducing rates on longer stays, or other similar strategies to increase lengths of stays. Accordingly, the performance platform interface 350 may be utilized by hotels to easily view aggregated booking data from bookings through a variety of suppliers. Such data may be displayed in graphical formats, such that it is easier for hotels to view trends and/or possible avenues of improvement of the hotel's performance score.

In various examples, the performance platform interface 350 may include additional tiles and/or elements including information intended to help a hotel improve its performance (e.g., to increase its performance score). For example, the performance platform interface 350 may display information about specific actions a hotel may take in order to improve its performance score. For example, the booking coordination system 102 may collect data indicating that hotels with complete profiles are more likely to be booked through a supplier system 104 in communication with the booking coordination system 102. Accordingly, where a hotel does not have a complete profile, the booking coordination system 102 may suggest, via the performance platform interface 350, that the hotel complete its profile at the supplier system 104. Similarly, the booking coordination system 102 may suggest, via the performance platform interface 350, various promotions, advertising campaigns, and other actions which may help a hotel to obtain more bookings and/or to increase its performance score.

In some examples, the performance platform interface 350 may display alerts for real-time issues affecting the hotel's performance score that the hotel may be able to address immediately. For example, a user (e.g., via a user device 114) may leave a negative review of the hotel on a supplier system 104. Where the negative review is associated with a known booking through the supplier system 104 (e.g., the booking is included in booking data 126), the performance platform interface 350 may notify the user of the negative review, the text of the negative review, and the associated reservation or booking information. Using such information, the hotel may be able to address the customer's issue (where the booking information shows the customer is still staying at the hotel) and/or contact the customer to rectify the issue or issues reflected in the review. In various examples, such notifications may be provided automatically upon reloading the performance platform interface 350. In some examples, the booking coordination system 102 may otherwise provide notifications to the hotel device 112 (e.g., using push notifications or similar).

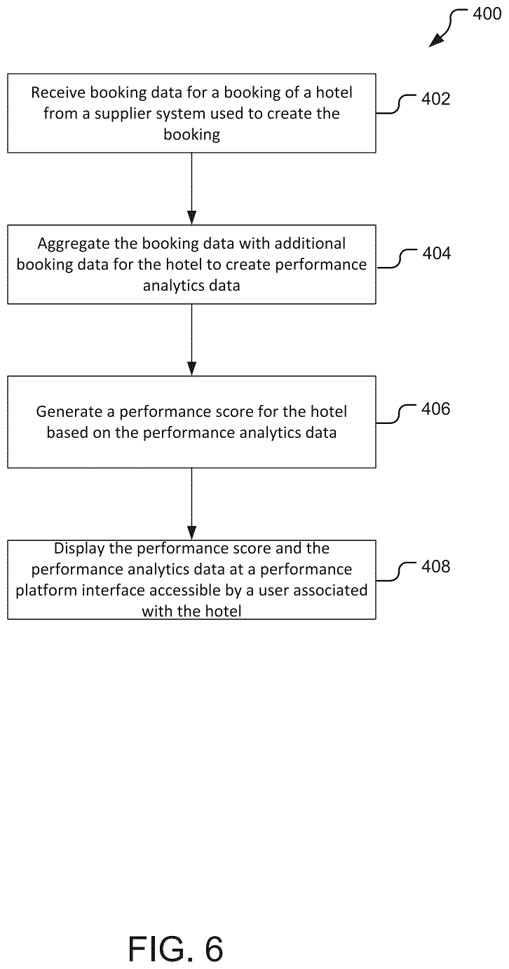

FIG. 6 illustrates an example process 400 for generation of a performance score by a booking coordination system. The process 400 may, in various examples, be used to generate a performance platform interface showing the performance score in near real-time. That is, the performance score may be regularly updated and/or generated based on up to date booking information from a variety of supplier systems. Accordingly, a hotel and/or entities managing a hotel may have the ability to continually track hotel performance.

At block 402, the booking coordination system 102 (e.g., at the systems interface 124) receives booking data for a booking of a hotel from a supplier system 104 used to create the booking. In various examples, the booking coordination system 102 may be configured to receive such booking data responsive to the booking being created at the supplier system 104. In some examples, the booking coordination system 102 may regularly query the supplier system 104 to obtain data about new bookings for the hotel made through the supplier system 104. In some examples, the booking coordination system 102 may, additionally or alternatively, query the supplier system 104 to obtain additional booking data responsive to a request, from a hotel device 112 to view a performance platform interface.

The booking coordination system 102 aggregates the booking data with additional booking data for the hotel to create performance analytics data at block 404. In various examples, the systems interface 124 may, upon receipt of the booking data from the supplier system 104, transmit the booking data to booking data configuration 122 for aggregation. In various examples, aggregation may include formatting the booking data (e.g., to match a format used to store the booking data by the booking coordination system 102) and/or storing the booking data with other booking data (e.g., previously collected booking data, booking data received from other supplier and/or hotel systems, and the like). Such storage may store the booking data locally (e.g., as booking data 126 at memory 118) and/or at a storage location accessible by the booking coordination system 102 (e.g., at datastore 108).

Once the newly received booking data is aggregated, booking data configuration 122 may utilize the aggregated booking data to generate performance analytics data. The performance analytics data may include any number of data points, but may generally be data showing overall trends and/or averages in the aggregated booking data. For example, performance analytics data may include number of bookings, average occupancy rate, average number of nights per booking, average room rate across bookings, and similar measures. In some examples, the types of data generated as performance analytics data may depend on characteristics of the hotel, such as location, size, general market, subscription level, and the like.

At block 406, the booking coordination system 102 generates a performance score for the hotel based on the performance analytics data. In various examples, the formula used to calculate the performance score may be based on number of bookings, rates per booking, percentage occupancy of the hotel, number of supplier systems being utilized to generate bookings, and the like. The performance score may, in various examples, be calculated differently based on a number of factors affecting and/or applicable to the hotel. For example, some performance analytics data points may be scaled (e.g., weighted more or less) for specific types and/or categories of hotels. Such types and/or categories of hotels may be referred to as situational factors. For example, a performance analytics data point may measure the deviations between occupancy rates in different months, where higher performing hotels may have relatively consistent occupancy rates across different months, seasons, and/or other units of time. This data point may be scaled so it is taken into less consideration for hotels primarily serving highly seasonal destinations, such as ski resorts, beaches, and the like. Accordingly, the performance score may be useful for comparing performance of hotels, even where the hotels are differently situated with respect to location, class of travelers served, relative price point, and the like. In various examples, the booking coordination system 102 may store the calculated performance score, performance analytics data, metrics, and/or other information for later use. For example, the booking coordination system 102 may store such information at a datastore 108 accessible by the booking coordination system 102.

The booking coordination system 102 displays the performance score and the performance analytics data at a performance platform interface accessible by a user associated with the hotel at block 408. In various examples, the booking coordination system 102 may further display other indicators of hotel performance to enable a quick visual assessment of the hotel performance, such as for potential customers that may want to book the hotel. Such indicators may include a badge or other graphic icon indicating a high performance hotel, e.g., gold badge that indicates top customer service performance for the property. In various examples, the badge or graphic may be displayed when the performance score of a hotel is above a certain threshold, e. g., less than 10 customer complaints per quarter or more than 30 customer positive reviews within a particular time period. In other words, the badge may be based on either a maximum number of negative reviews or issues by customers and/or a minimum number of positive reviews or issues by customers within a particular time period, e.g., every month, quarter, or year. In some embodiments, the customer service badge may be displayed adjacent to the property information, such as within a results list or other screen including one or more hotel properties, such that a user can visually identify desirable or high performance properties within a listing.

With continued reference to FIG. 6, after the performance score is calculated (and optionally may be able to be displayed), booking data configuration 122 may communicate the performance score to performance platform configuration 120 for configuration of the performance platform interface (e.g., interface 300 and/or 350) for display at the user interface 132 of the hotel device 112. In some examples, booking data configuration 122 may further communicate the calculated performance analytics data, which may be displayed in the performance platform interface. In some examples, booking data configuration 122 may further communicate various metrics generated from the booking data. Such metrics and/or the performance analytics data may be utilized by performance platform configuration 120 in generating graphical representations of the booking data for display at the hotel device 112. For example, tiles 352-366 of the interface 350 may be configured and/or generated using various metrics and/or performance parameters received from booking data configuration 122.

After the interface is configured by booking data configuration 122, the systems interface 124 may communicate with the hotel device 112 to display the interface at the user interface 132 of the hotel device. In various examples, the interface may be operable to receive input from a user at the hotel device 112 which may be utilized by the booking coordination system 102 and/or may be communicated by the booking coordination system 102 to one or more of the supplier systems 104a-104n in communication with the booking coordination system 102. For example, the platform performance interface may display steps the hotel can take to increase its performance score, such as completing profile information for the hotel at the supplier systems 104a-104n. In some examples, the interface may collect information for completing such profiles, which the booking coordination system 102 may communicate to the supplier systems 104a-104n.

In various examples, the process 400 may repeat when a user at the hotel device 112 refreshes the interface (e.g., when the interface is viewed via a web browser) and/or otherwise requests to view updated booking data. Accordingly, a hotel may view its performance in near real-time, seeing how additional bookings, information, and/or actions taken by the hotel may affect its performance score. Relatedly, the performance information may be visible and displayed on a customer user interface, such as in the form of a badge, graphic, or numeric score, that may be presented along with the hotel as an option for booking, e.g., in a results list of multiple properties. In this manner, a user may be able to quickly identify hotels with positive or negative performance, allowing a user to quickly and easily make a selection for booking, without having to navigate through multiple layers of screens and menus to identify the hotel performance.

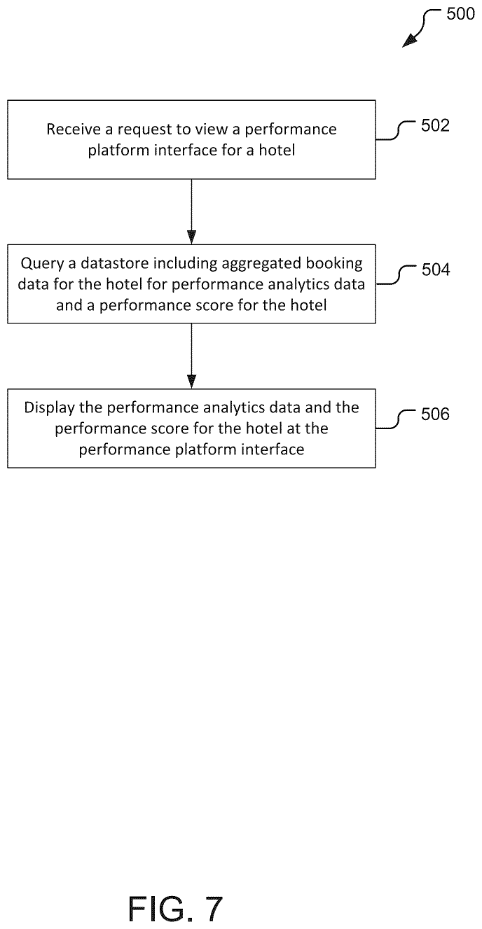

FIG. 7 illustrates an example process 500 for configuring a performance platform interface by a booking coordination system. The booking coordination system 102 receives a request to view a performance platform interface for a hotel at block 502. The request may, in various examples, be received from the hotel device 112 in communication with the booking coordination system 102. The request may be received by the booking coordination system 102 via the systems interface 124, in various examples. The request may generally be associated with one or more hotels. In some examples, the request may further be associated with a time period. For example, a user may wish to view performance information for a hotel over the preceding year, month, or other period of time.

At block 504, the booking coordination system 102 queries a datastore including aggregated booking data for the hotel for performance analytics data and a performance score for the hotel. Upon receipt of the request at the systems interface 124, the request may be provided to performance platform configuration 120. Performance platform configuration 120 may access interface data 128 and/or hotel data 130 to determine what type of data is needed to generate the performance platform interface for the hotel. For example, performance platform configuration 120 may access hotel data 130 to determine interface settings specific to the hotel. Based on the interface settings (e.g., which data is viewable at the performance platform interface for the hotel), performance platform configuration 120 may access interface data 128 to locate a template for the interface, queries for obtaining additional data and the like.

In various examples, performance platform configuration 120 may determine an age of the aggregated booking data and may, where the age is above a certain threshold (e.g., 10 minutes), communicate with the systems interface 124 and/or booking data configuration 122 to obtain updated booking data from the supplier systems 104 and/or the hotel system 106 and to generate updated performance analytics data and/or an updated performance score. For example, the booking coordination system 102 may perform all or part of the process 400 to obtain updated booking data and/or generate an updated performance score.

The booking coordination system 102 displays the performance analytics data and the performance score for the hotel at the performance platform interface at block 506. Once performance platform configuration 120 has received the performance analytics data and the performance score, performance platform configuration 120 may format the data, create various graphical representations of the data, plug the data into templates for the performance platform interface, and the like, to generate the performance platform interface. For example, performance platform configuration 120 may generate one or more graphics such as those in tiles 352-366 of the interface 350, for display at a user interface 132 of the hotel device 112. When the performance platform interface is configured, the systems interface 124 may communicate with the hotel device 112 to display the performance platform interface.

In various examples, the booking coordination system 102 may further display, at the performance platform interface, information about actionable items affecting a hotel's rating. Such items may include actions the hotel can take with respect to the supplier systems 104 (e.g., completing a profile at the supplier system 104) and/or actions the hotel can take to address customer problems in real-time. For example, the performance platform interface may display and/or notify the user of negative user reviews in real-time or near real-time, so that the hotel may quickly address a customer's concerns.

In accordance with the above examples, a booking coordination system 102 is provided which utilizes booking data received through various systems (e.g., supplier systems 104a-104n and hotel systems 106) to quantify and track hotel performance. The booking coordination system 102 provides access to data about hotel bookings from multiple locations and formats such data into a useful interface for tracking performance. Further, such interfaces may be generated based on real-time or near real-time data, such that hotel performance may be tracked, for example, daily or weekly. The booking coordination system 102 further generates a performance score, which may be useful to customers, travel agents, groups, and others booking hotel rooms on behalf of individuals, to compare various hotels. The performance score may further provide an objective metric for hotels to gauge performance, the booking coordination system 102 may provide actionable steps by which a hotel may improve its performance score.

Though the booking coordination system 102 is described with respect to hotels, the booking coordination system 102 may be used by other similar businesses or properties taking reservations, such as property management companies, resorts, short-term rental companies, and the like. The booking coordination system 102 may also similarly be used by businesses utilizing reservations, such as restaurants, zoos, museums, theme parks, guided tours, and the like.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of the invention as defined in the claims. Although various embodiments of the claimed invention have been described above with a certain degree of particularity, or with reference to one or more individual embodiments, it is appreciated that numerous alterations to the disclosed embodiments without departing from the spirit or scope of the claimed invention may be possible. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. A hotel booking coordination system comprising:
a systems interface configured to receive booking data for bookings of a hotel from at least a first supplier system and a second supplier system, wherein the first supplier system and the second supplier systems interface with the hotel booking coordination system; and
a performance platform configuration element configured to generate a user interface displaying at least performance analytics data for the hotel and a performance score for the hotel, wherein the performance analytics data and the performance score are determined based on the booking data from at least the first supplier system and the second supplier system.

2. A method comprising:
receiving booking data for a booking of a hotel from a first supplier system used to create the booking;
aggregating the booking data with additional booking data for the hotel to create performance analytics data, wherein the additional booking data includes data for bookings of the hotel from at least a second supplier system used to create the bookings;
generating a performance score for the hotel based on the performance analytics data; and
displaying the performance score and the performance analytics data at a performance platform interface accessible by a user associated with the hotel.

3. The method of claim 2, wherein aggregating the booking data with the additional booking data comprises formatting the booking data to match a format utilized by a datastore storing the additional booking data.

4. The method of claim 2, wherein generating the performance score for the hotel further comprises generating the performance score for the hotel based on one or more situational factors applicable to the hotel.

5. The method of claim 2, wherein the additional booking data further includes data for booking of the hotel from a hotel system used to create the bookings.

6. The method of claim 2, wherein the booking data comprises one or more of a number of nights in the booking, a room rate applied to the booking, the first supplier system used to make the booking, and an entity type making the booking.

7. The method of claim 2, wherein the performance platform interface further displays one or more actions for the hotel to improve the performance score.

8. A method comprising:
receiving a request to view a performance platform interface for a hotel;
querying a datastore including aggregated booking data for the hotel for performance analytics data and a performance score for the hotel; and
displaying the performance analytics data and the performance score for the hotel at the performance platform interface.

9. The method of claim 8, wherein the performance platform interface further displays one or more actions for the hotel to improve the performance score.

10. The method of claim 8, wherein the aggregated booking data includes booking data for bookings of the hotel made using at least two supplier systems.

11. The method of claim 8, wherein the performance score is generated based on the performance analytics data, wherein the performance analytics data is generated based on the aggregated booking data.

12. The method of claim 8, further comprising generating, responsive to the request to view the performance platform interface for the hotel, the aggregated booking data using booking data from at least a first supplier system and a second supplier system.

13. The method of claim 12, further comprising querying the first supplier system and the second supplier system for the booking data.
